(19) United States
(12) Patent Application Publication
(10) Pub. No.: US 2010/0026649 A1
(43) Pub. Date: Feb. 4, 2010

(54) INFORMATION PROCESSING APPARATUS AND CONTROL METHOD THEREOF

(75) Inventors: Tomoyuki Shimizu, Yokohama-shi (JP); Hiroyuki Nagai, Sakai-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/509,723

(22) Filed: Jul. 27, 2009

(30) Foreign Application Priority Data
Jul. 31, 2008 (JP) 2008-198621 (PAT.

(51) Int. Cl. G06F 3/041

(52) U.S. Cl. 345/173

(57) ABSTRACT

In an information processing apparatus for controlling a multi-touch panel, a contacted area acquisition unit acquires a contacted area contacted in the multi-touch panel, and a side of hand determination unit determines whether or not the acquired contacted area has a predetermined shape. If it is determined that the contacted area has a predetermined shape, a selected range placing unit places a selected range based on a detected position in the contacted area, and displays the placed selected range in the multi-touch panel.

### BACKGROUND OF THE INVENTION

1. Field of the Invention

The present invention relates to an information processing apparatus comprising a multi-touch panel and a control method thereof.

2. Description of the Related Art

In recent years, the number of devices having a touch panel function have been increasing, ranging from small displays equipped in portable appliances, such as game machines and music players, to relatively large displays used in presentations for conferences and lectures.

Since touch panel displays enable the user to manipulate displayed objects with intuitive instructions, they are becoming popular in a variety of fields, regardless of the age or sex of the user. To perform an input to a touch panel display, a touch input that specifies a range including a subject object is needed for operations such as the manipulation and the selection of the object.

Generally, as a method for selecting an object for manipulation, there are methods such as:
directly specifying an object for selection by touching a point on the object with a finger or a pen, and
in a case in which a plurality of objects is to be selected, indicating the objects to be selected by moving a touch input point so as to surround all the objects. (Refer to Japanese Patent Laid-Open No. 01-142969.)

In recent years, touch panels having a sensor that can detect multiple touches at multiple positions at the same time are coming into existence (hereinafter referred to as “multi-touch panel”).

With such displays having a multi-touch panel, it is becoming possible to specify a range with an action that surrounds the range with both hands (Refer to Tse, E.; Greenberg, S.; Shen, C.; Forlines, C., “Multimodal Multiplayer Tabletop Gaming”, International Workshop on Pervasive Gaming Applications (Per Games), May 2006.).

However, there are the following problems with these methods.

First, only positions that can be reached by the hand can be specified.

This is a particularly significant restriction for people who have a small body and disabled people, etc., when specification of a large area is necessary during a conference or a lecture utilizing a large display.

Furthermore, although there may not be a problem when a range only needs to be specified once, in a case when ranges must be repeatedly specified a number of times during a conference or lecture, the physical effect is large, particularly for the aforementioned restricted people. For example, it is difficult for a small child to perform a process for specifying large areas many times on a large display.

### SUMMARY OF THE INVENTION

The present invention was achieved in view of the aforementioned problems. According to one embodiment of the present invention, there is provided a method for the user of a touch panel to easily specify an area including a range that cannot be easily reached by a hand.

According to one aspect of the present invention, there is provided an information processing apparatus for controlling a multi-touch panel, comprising: an acquisition unit configured to acquire a contacted area in the multi-touch panel; a determination unit configured to determine whether or not the contacted area acquired by the acquisition unit has a predetermined shape; and a placing unit configured to place a selected range based on a detection position in the contacted area if the determination unit determines that the contacted area has the predetermined shape.

Furthermore, according to another aspect of the present invention, there is provided a method for controlling an information processing apparatus that controls a multi-touch panel, comprising: acquiring a contacted area contacted in the multi-touch panel; determining whether or not the acquired contacted area has a predetermined shape; placing a selected range based on a detection position of the acquired contacted area if the acquired contacted area is determined to have the predetermined shape; displaying the placed selected range in the multi-touch panel.

Further features of the present invention will become apparent from the following descriptions of the exemplary embodiments with reference to the attached drawings.

### BRIEF DESCRIPTION OF THE DRAWINGS

FIG. 1 is a block diagram showing an example of an arrangement of an information processing device according to a first embodiment.

FIG. 2 is a block diagram showing a functional arrangement of the information processing device according to the first embodiment.

FIGS. 3A and 3B are diagrams showing images of detection states of sensors that have detected a side of a hand on a multi-touch panel in the information processing device according to the first embodiment.

FIG. 4 is a flowchart showing a procedure of a process for placing an initial selected range circle in the information processing device according to the first embodiment.

FIG. 5 is a flowchart showing a procedure of processes such as translation, rotation, magnification, and reduction of a selected range circle in the information processing device according to the first embodiment.

FIG. 6 is a flow chart showing a procedure of a process for fixing a selected range in the information processing device according to the first embodiment.

FIG. 7 is a diagram showing an example of obtaining a selected range circle from the detected area of a side of a hand in the information processing device according to the first embodiment.

FIGS. 8A and 8B are diagrams showing an example of placing a selected range circle when a side of a hand is placed on the multi-touch panel in the information processing device according to the first embodiment.

FIGS. 9A and 9B are diagrams showing an example of translation and rotation of a selected range in the information processing device according to the first embodiment.

FIGS. 10A to 10C are diagrams showing an example of performing magnification and reduction of a selected range in the information processing device according to the first embodiment.

FIGS. 11A and 11B are diagrams showing an example of a process for magnifying an object in the fixed selected range in accordance with the magnification of the selected range in the information processing device according to the second embodiment.

FIG. 12 is a diagram showing an example of a process for rotating an object in the fixed selected range in accordance with the rotation of the selected range in the information processing device according to the second embodiment.

FIG. 13 is a diagram showing an example of performing modification of a selected range in the information processing device according to the fourth embodiment.

FIG. 14 is a diagram showing an example that sets a graphic inscribed within the selected range circle as the selected range in the information processing device according to the fourth embodiment.

FIGS. 15A and 15B are diagrams showing an example of rotation of a graphic inscribed within a selected range circle in the information processing device according to the fourth embodiment.

### DESCRIPTION OF THE EMBODIMENTS

Hereinafter, details of a preferred embodiment of the present invention will be described with reference to the drawings.

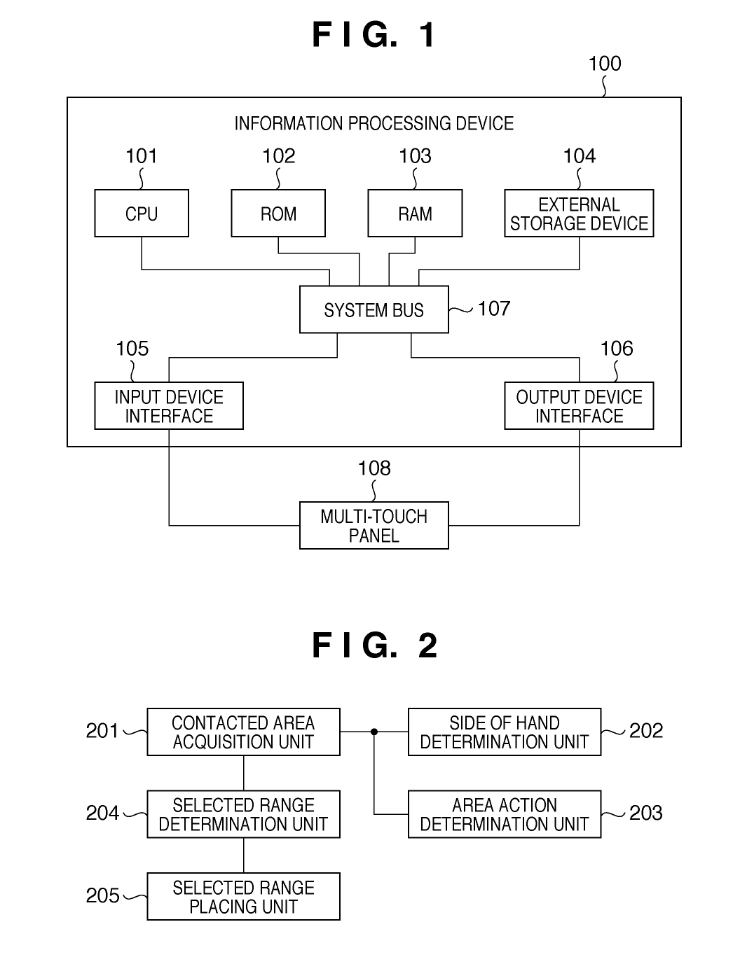

FIG. 1 is a block diagram showing an example of an arrangement of an information processing device according to the present embodiment.

In FIG. 1, a Central Processing Unit (CPU) 101 controls the entire information processing device 100. A Read Only Memory (ROM) 102 stores programs and parameters that need not be changed. A Random Access Memory (RAM) 103 temporarily stores programs and data supplied from an external storage device, for example. An external storage device 104 includes a hard disc or a memory card fixedly provided in the information processing device 100. As for the external storage device 104, it may include an optical disc such as a flexible disk (FD) and a compact disc (CD), a magnetic or optical card, an IC card, and a memory card, removable from the information processing device 100. An interface 105 inputs data in response to the manipulation by the user on a multi-touch panel 108. An interface 106 is for displaying data held in the information processing device 100 or supplied data on the display (display panel) of the multi-touch panel 108. A system bus 107 connects each of the units 101-106, enabling communications between them. The input device interface 105 and the output device interface 106 are both connected to the multi-touch panel 108.

The multi-touch panel 108 includes a touch input panel and a display panel. The touch input position (a coordinate of a contact point) on the touch input panel (contact surface) is input to the information processing device 100 via an input device interface 105, and the display information from the information processing device 100 to the display panel is output from the output device interface 106.

In the present embodiment, the information processing program code including the implementation of the present invention is stored in the external storage device 104 and is executed by the CPU 101. The user performs manipulations using the multi-touch panel 108 and obtains a response from the same multi-touch panel 108. The information processing program code may be stored in the ROM 102.

The multi-touch panel according to the present embodiment is able to detect a plurality of contact points included on the contact surface at the same time. However, there are no restrictions to the detection method (sensor) as long as it is able to detect a plurality of contact points at the same time. Furthermore, a contact by the user is not necessarily needed as long as an area that corresponds to the contact point can be acquired. Examples include acquiring the area as an image utilizing optical sensors. Additionally, the sensor need not be limited to one sensor, and a plurality of sensors may be combined so as to use a capacitance sensor for detecting a contact with human skin and an optical sensor to determine that it is an instructed area or a human hand, for example.

FIG. 2 is a block diagram for illustrating a functional arrangement of the information processing device according to the present embodiment.

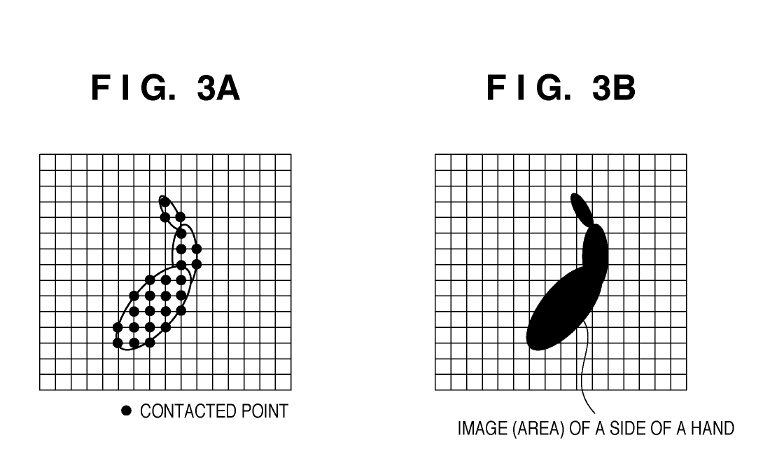

In FIG. 2, a contacted area acquisition unit 201 detects contact of a hand, etc., to the multi-touch panel 108, and acquires the detected area. The detected image on the multi-touch panel is as shown in FIGS. 3A and 3B. In this example, a situation is shown where an area of a side of a hand is detected. As shown in FIG. 3A, in the case of a method that detects contact points, a plurality of contact points grouped with a certain range of densities are detected at nearly the same time, since the entire surface of the contacted portion contacts the multi-touch panel. The contacted area acquisition unit 201 acquires, as a contacted area, an area where a plurality of contacted positions that are detected by the multi-touch panel 108 at the same time have a density equal to or greater than a pre-determined density. Thus, by distinguishing a collection of contact points grouped by having a certain range of density as a contacted area, even if there were contacts of similar portions of a human body in multiple positions on the multi-touch panel at the same time, it is able to acquire those contacted areas while distinguishing the areas from each other. Moreover, as shown in FIG. 3B, since continuous surface areas of individual hands can be acquired as images in the method that uses optical sensors, a more precise area can be acquired. Although an example that assumes contact with a multi-touch panel is described above, the invention is not limited to this, and a manipulation instruction area of the user can be acquired as an image even without contact, in a case in which a method that uses optical sensors is utilized, for example. In this case, a hand does not necessarily need to contact the panel.

A side of hand determination unit 202 determines whether or not an area acquired by the contacted area acquisition unit 201 is acquired by detecting a contact of the side of a hand. In determining whether or not the acquired area is the side of a hand, there is a situation in which only inputs from a finger and from a pen need to be distinguished, and in such a situation, a method that estimates by the differences in the size of the area may be used. This method utilizes apparent differences between the size of an area when a finger or a pen is detected and the size of the area of a side of a hand.

On the other hand, in a situation where there are many kinds of areas that need to be distinguished from a side of a hand, estimation cannot easily be done simply from the size of the area. In such a case, an estimation method by pattern matching of the detected area may be used. The pattern matching will be hereinafter described.

Firstly, learned patterns are generated in advance, the learned data being area information (distribution of contact points included in the area, etc.) acquired when the sides of hands of many people are detected. When there is an input to the multi-touch panel, it is determined to be a side of a hand if a similar pattern exists within the learned patterns, and it is deemed not to be a side of a hand if a similar pattern does not exist. It is possible to presume a side of a hand by the determination process above. In order to improve the accuracy of this process, area information of the side of a hand of a user actually utilizing the multi-touch panel may be registered in advance as a learned pattern. Moreover, although the difficulty of strict estimation from only the size of the area has already been mentioned, it is possible to narrow down the targets of pattern matching determination processing by simultaneously using area information.

Furthermore, in the case in which a method utilizing the optical sensor shown in FIG. 3B can be used, the accuracy of detection of the side of a hand can be improved by performing a recognition process utilizing colors, shapes, etc., and simultaneously using the contact point information, for example.

Moreover, although cases that determine the side of a hand automatically were described above, automatic determination is not necessary. For example, accuracy may be further improved by explicitly indicating contact by the side of a hand through the multi-touch panel 108, etc. For example, a button area for specifying contact by the side of a hand on the multi-touch panel 108 may be provided, and contact by the side of a hand may be explicitly indicated by a user indicating this.

When the side of a hand is determined, the directions of the palm and backside of the hand in the are of the side of the hand are simultaneously attached. As for the shape of a hand utilized in the present embodiment, since it is assumed that the palm of a hand is slightly curved, which side in the area is the palm side of a hand can be determined from the shape of the detected area.

If it is determined by the side of hand determination unit 202 that the area acquired in the contacted area acquisition unit 201 includes the side of a hand, an area action determination unit 203 monitors actions, such as translation and rotation of the area, and opening and closing actions of the palm of the hand to determine whether those actions are to be performed or not.

If it is determined in the side of hand determination unit 202 that the area acquired in the contacted area acquisition unit 201 is a side of a hand, a selected range determination unit 204 determines the size of the selected range from the shape of the area. In the present embodiment, the selected range is circular. A method that determines two points 701 at both ends of the detected area of the side of the hand and one intermediate point 702, and obtains from these three points a circle including them, as shown in, for example, FIG. 7, can be given as a method for determining the size of the selected range from the shape of the area. Alternatively, since a plurality of contact points are detected from a side of a hand as shown in FIG. 3A, an approximate circle may be obtained from the distribution of the contact points and used.

A selected range placing unit 205 places a selected range determined in the selected range determination unit 204 onto a palm side of a hand in the area of the side of a hand, which contacts the multi-touch panel 108.

Each of the aforementioned functional units 201-205 are implemented by the CPU 101 executing a program stored in the ROM 102 or a program loaded into the RAM 103 from the external device 104.

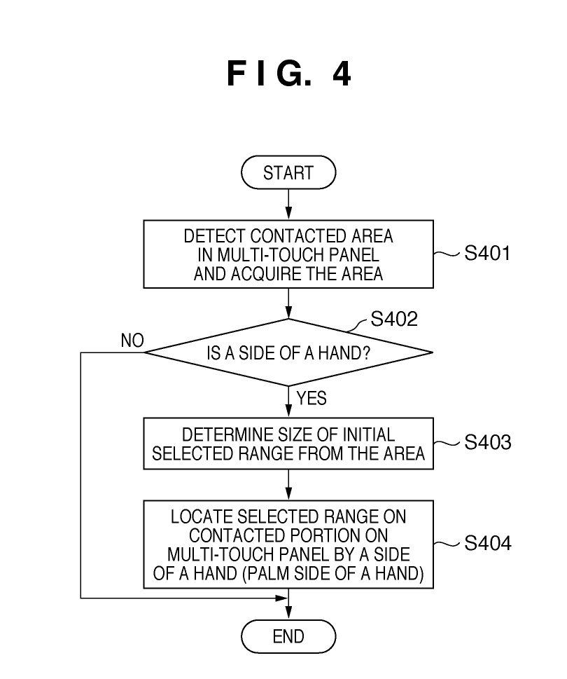

Now, the operation of the information processing device according to the present embodiment will be described with reference to flowcharts shown in FIGS. 4 to 6.

The flowchart shown in FIG. 4 shows a procedure of a process for placing a selected range on the multi-touch panel onto a side of a hand when it is placed on the multi-touch panel. In step S401, the contacted area acquisition unit 201 detects contact of a hand, etc., on the contact surface of the multi-touch panel 108 to acquire the contacted area.

In step S402, whether or not the contacted area acquired in step S401 has a predetermined shape is determined. In the present embodiment, the side of hand determination unit 202 determines whether or not the contacted area acquired in step S401 is a side of a hand, as described above. If it is determined that the contacted area has a predetermined shape (in the present embodiment, if it is determined that it is a side of a hand), the process proceeds to step S403 and the selected range is placed based on the detected position of the contacted area. If it cannot be determined to be a side of a hand, the process ends.

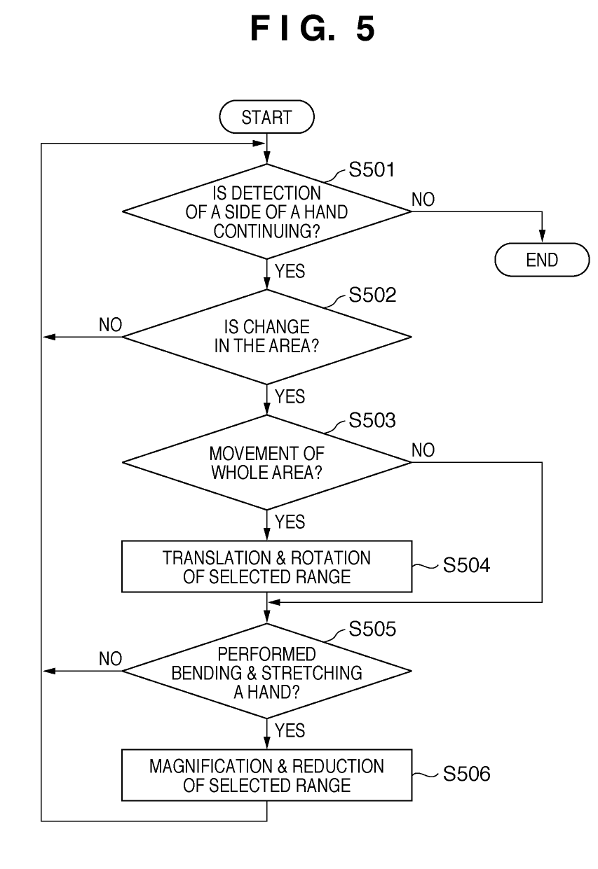

In step S403, the selected range determination unit 204 determines the size of the selected range based on the contacted area. In the present embodiment, a size of the initial selected range circle is determined from the detected shape of the area of the side of a hand. Moreover, although the size of the initial selected range circle is determined dynamically based on the shape of the contacted area by the selected range determination unit 204 in the present embodiment, it is not limited to this, and a size of the initial selected range circle may be determined in advance. In this case, although there is no benefit to determining the size in accordance with the shape of a hand, it is possible to reduce the calculation cost for performing the determination so that the fine adjustment is performed in the process shown in the hereinafter described flow in FIG. 5. If the size of the initial selected range circle is determined in advance, the size may have a system-defined value, or may be set by the user. If a predetermined circle is used for the initial selected range circle, the process skips step S403 and proceeds to step S404 after the side of a hand is recognized in step S402.

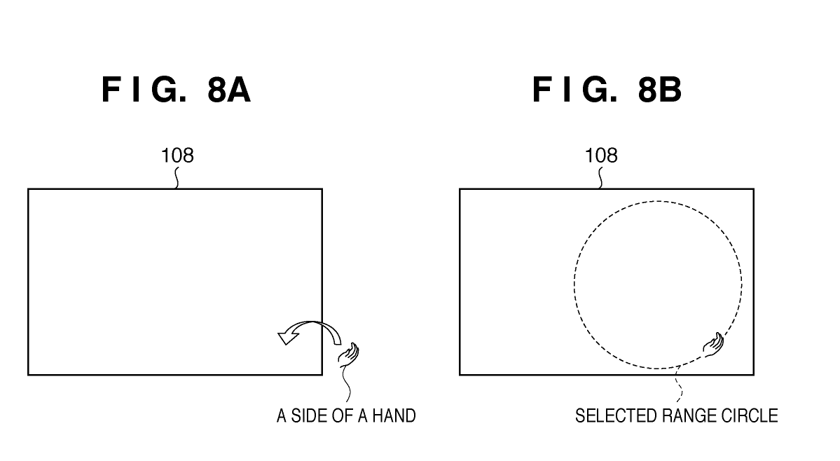

In step S404, the selected range placing unit 205 places the initial selected range circle having a size determined in step S403 on the multi-touch panel 108. In the present embodiment, the contacted area of a side of a hand has a curved shape, and the selected range placing unit 205 places the selected range circle having a size determined by the selected range determination unit 204 based on this curved shape such that it lies beside the curved shape. In other words, the selected range placing unit 205 places the selected range circle beside the palm side of a hand of the area of the side the hand on the multi-touch panel 108. The selected range placing unit 205 displays the placed selected range on the multi-touch panel 108. The above process will be explained more specifically with reference to FIGS. 8A and 8B. When a side of a hand is placed onto the multi-touch panel 108 (FIG. 8A), the size of the initial selected range circle is determined based on the contact area of the side of a hand (step S401-S403). The initial selected range circle having the aforementioned size is placed so as to lie beside the palm side of the side of a hand (FIG. 8B and step S404).

FIG. 5 is a flowchart showing a procedure of a process that performs translation, rotation, magnification, and reduction on the selected range circle placed by the process shown in FIG. 4, in accordance with a motion of a side of a hand. The process shown in FIG. 5 is a continuation of the process shown in FIG. 4, and it starts from a situation in which a side of a hand is in a state of contact and the selected range is placed so as to lie beside the area of the side of a hand.

First, in step S501, the side of hand determination unit 202 monitors whether or not the side of a hand is in a state of contact. If the area of the side of a hand is maintaining a state of contact, the process proceeds to step S502. If it is no longer in a state of contact, the process ends.

In step S502, the area action determination unit 203 monitors whether or not there is a change in the area. If there is a change in the area, the process proceeds to step S503. If there is no change in the area, the process proceeds to step S501 and monitoring of the state of contact of the area of the side of the hand is continued.

In step S503, the area action determination unit 203 determines whether the change includes a movement involving the entire area. If there is a movement involving the entire area, the process proceeds to step S504, and movement of the selected range is performed in accordance with the movement of the contacted area (e.g., translation and rotation), as will be hereinafter described in detail. If not, the process proceeds to step S505. Whether or not the movement involves the entire area can be confirmed by checking whether the area has moved to another coordinate while the size and the shape of the area have been substantially maintained.

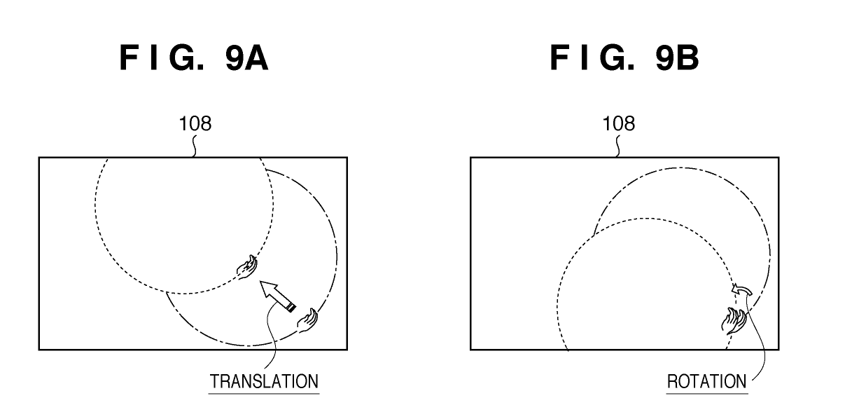

In step S504, since there is movement involving the entire area, the selected range placing unit 205 performs translation or rotation of the placed selected range in accordance with the movement of the area. In other words, the selected range is moved in accordance with the movement of the side of a hand while maintaining the positional relationship with the side of a hand, as in FIGS. 9A and 9B. Moreover, although the selected range moves beyond the boundary of the multi-touch panel by the manipulation in the examples in FIGS. 9A and 9B, in this case, this specification in a range outside the multi-touch panel only needs to be determined to be valid or invalid, and either is possible.

In steps S505 and S506, the size of the selected range is changed in accordance with the change in the shape of the contacted area. First, in step S505, the area action determination unit 203 determines whether or not the change includes an action of bending and stretching the side of a hand. If the change in the area includes an action that corresponds to the bending and stretching of the side of a hand, the process proceeds to step S506. If not, the process proceeds to step S501 and monitoring is continued.

For example, whether or not the action involves bending and stretching of the side of a hand may be determined by obtaining an approximated curve from the detected contact point and monitoring the change of the curvature of the curve. Alternatively, in a case in which an optical sensor is provided, etc., the shape of the hand itself can be acquired, and determination may be done from that shape.

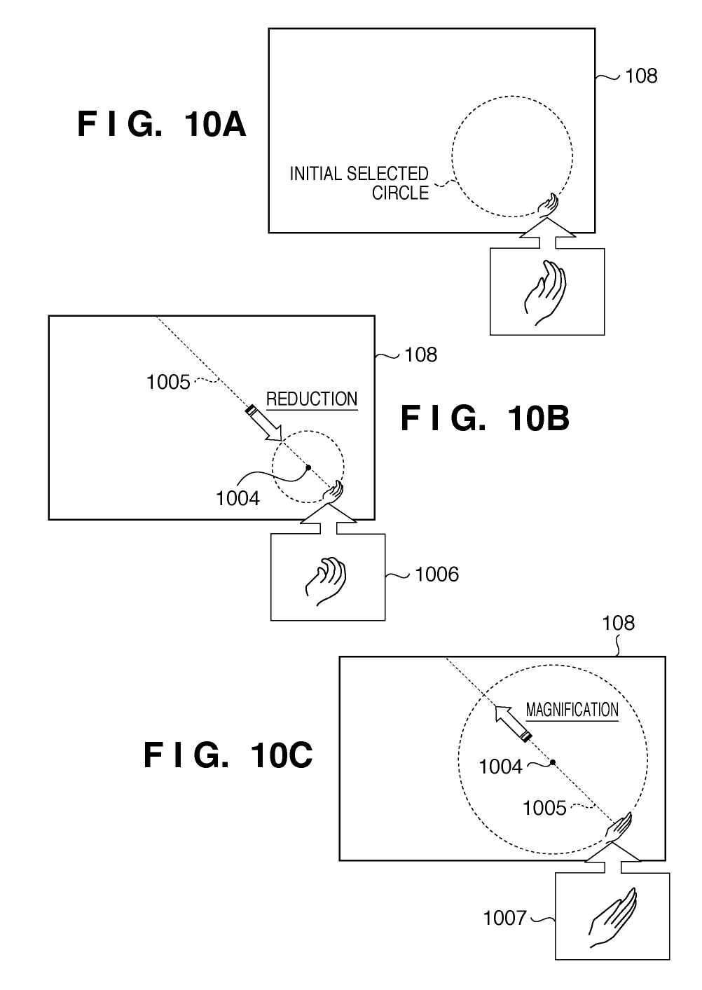

In step S506, the selected range determination unit 204 performs reduction and magnification of the selected range in accordance with the bending and stretching action of the side of a hand. Hereinafter, the reduction and magnification of the selected range according to the present embodiment will be described with reference to FIGS. 10A-10C.

As shown in FIG. 10B, if the change was a bending action (1006) of a side of a hand, reduction of the selected range circle is performed while maintaining the positional relationship between the selected range circle and the side of the hand. Reduction of the selected range circle is performed in the following manner, for example. First, the center point (1004) of the selected range circle is moved in the direction of the hand along a normal line (1005) that runs through a point in the center of the area of the side of a hand and a center point (1004) of the selected range circle. Then, the selected range circle having a distance from the center point after the movement to the center point of the area of the side of a hand as a radius is placed with the center point after the movement as its center. Thus, the situation proceeds from the state of FIG. 10A to the state of FIG. 10B to perform reduction of the selected range circle. On the other hand, in the case of a stretching action (1007) of the side of a hand as shown in FIG. 10C, the center point 1004 of the selected range circle is moved along the normal line 1005 in a direction to become further away from the hand to perform magnification of the selected range circle.

As for the size of the selected range circle after reduction or magnification, it may be recalculated using methods such as that described with reference to FIG. 7, or the amount of magnification and reduction may be determined from, for example, the amount and speed of the change (the size and speed of the gesture) of the bending and stretching action. As for the point in the center of the area of the side of a hand, for example, the center of an arc of the selected range circle that runs through the contacted area (a point on the arc equidistant from the points at both ends of the arc) may be used, for example. This corresponds to a point such as a point 702 in FIG. 7.

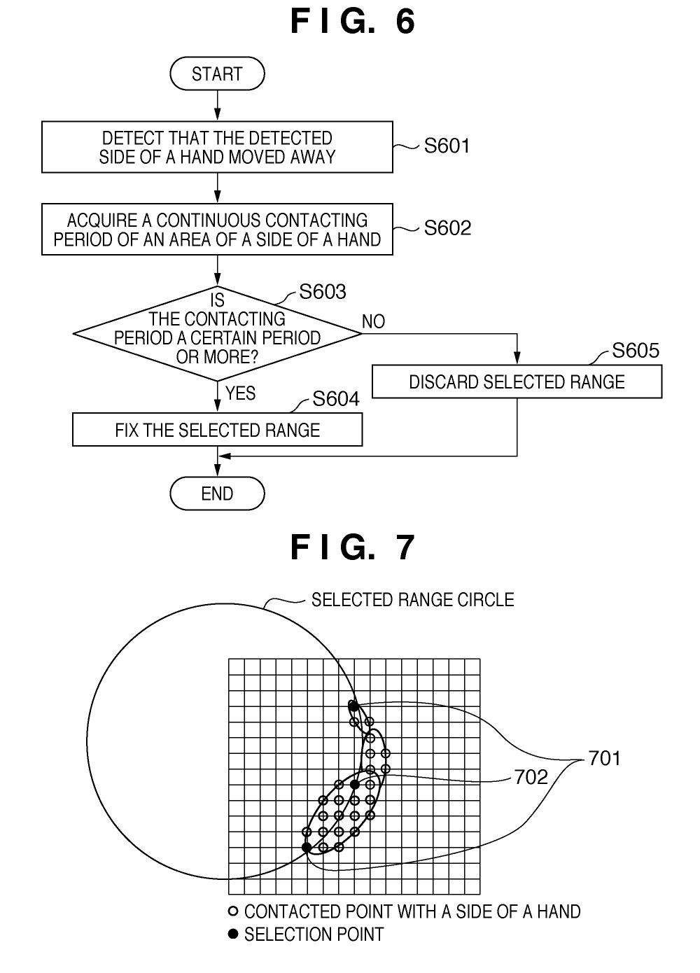

FIG. 6 is a flowchart showing an example of a procedure of a process for fixing the selected range placed onto the multi-touch panel by the process shown in FIGS. 4-5. In the flowcharts shown in FIGS. 4-5, prestage processing is performed to determine the selected range by placing the selected range, and moving, magnifying or reducing it. The flowchart in FIG. 6 is positioned as a process for fixing the selected range. The flowchart in FIG. 6 starts from a state in which the selected range is placed by performing the process shown in FIGS. 4-5. In the present embodiment, when the contacted area acquisition unit 201 detects the disappearance of the contacted area, the selected range placed at the selected range placing unit 205 is fixed. However, this is based on the condition that the contacted area has existed continuously for a predetermined period of time after the selected range was placed in the selected range placing unit 205. Hereinafter, the details will be explained.

First, in step S601, the contacted area acquisition unit 201 detects that the contacted area which has been detected has now disappeared, or that the area that can be determined as the side of a hand in the side of hand determination unit 202 has disappeared. Next, in step S602, the period of contact, which represents how long the area of a side of a hand was in continuous contact after placing the selected range, is acquired. For example, as for the starting time of contact with the side of a hand, a point in time when the area determined as a side of hand is detected by the side of hand determination unit 202 may be used. Therefore, by holding this starting time, it is possible to acquire the period of contact from the detection time in the step S601.

Then, in step S603, the selected range placing unit 205 determines whether or not the period of contact is greater than or equal to a predetermined period, and if contact has continued for a period exceeding a predetermined period, the process proceeds to step S604, and the selected range is fixed. If not, the process proceeds to step S605 and the selected range is discarded.

The fixing process of the selected range is not limited to the above, and may be any process as long as it is a process that involves a determination standard distinguishable from the range selecting process.

For example, if a change in area has not been detected for a certain period of time, the fixing process may be done while maintaining the state of contact of the side of a hand. Alternatively, the fixing of the selecting range may be done in response to an explicit instruction indicating a fixing process onto the multi-touch panel (e.g., a touch and a gesture to the button displayed on the multi-touch panel). Needless to say, physical buttons may be used. In addition, the fixing of the selected range may be done in response to the voice input, such as, “Fix the selected range”, by providing a voice input device such as a microphone and a voice recognition unit.

As is described above, in accordance with the first embodiment, manipulation can be easily done since the movement of a selected range and a change of the size can be done with a single hand.

The first embodiment shows a procedure of a process that places the selected range and fixes the selected range. However, implementation of the present invention is not limited to the above, and for example, it may be applied to processes such as translation, rotation, magnification, and reduction of an object included in the selected range after it is fixed. Depending on the method of the fixing process shown in the first embodiment, there are cases in which the side of a hand has already moved away from the multi-touch panel, and in this case, an additional process for associating the selected range to the area of the side of a hand which will be detected again becomes necessary. Examples of the association of the side of a hand to the fixed selected range include a method such as associating the side of a hand to the selected range when the area of the side of a hand is detected near the circumferential area of the fixed selected range (more generally, when a predetermined shape is detected within a predetermined distance from the selected range). As to a case that uses a method that fixes without moving the side of a hand away from the multi-touch panel (e.g., a case that fixes using physical buttons or a voice input), this association procedure is not necessary.

Thereafter, processes for translation, rotation, magnification, and reduction of the range is performed by processes similar to those in the flow shown in FIG. 5, and the objects included in the range are moved, magnified and reduced accordingly. The translation, rotation, magnification, and reduction of objects in accordance with the selected range can be handled collectively as an affine transformation of the objects.

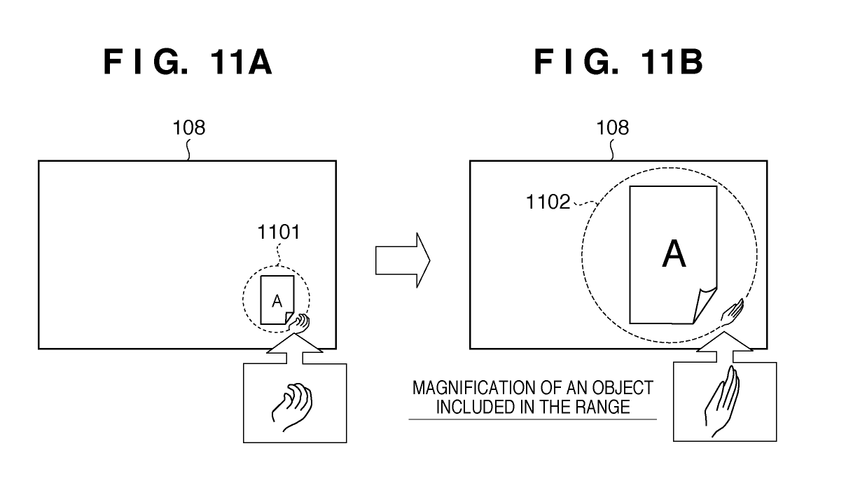

An example of the second embodiment is shown in FIGS. 11A and 11B. Here, an example is shown that magnifies an object included in an area of the selected range 1101 as shown in FIG. 11B after fixing the selected range 1101 on the multi-touch panel 108, as shown in FIG. 11A. By enlarging a central angle of a circular arc that is detected when the side of a hand is placed on the multi-touch panel 108, the object is magnified as shown by 1102, and in contrast, the object is reduced if the central angle is made smaller. For example, this is applicable to a case in which the object is manipulated to be magnified so as to be presented to the audience with improved visualization in presentations using a large type display.

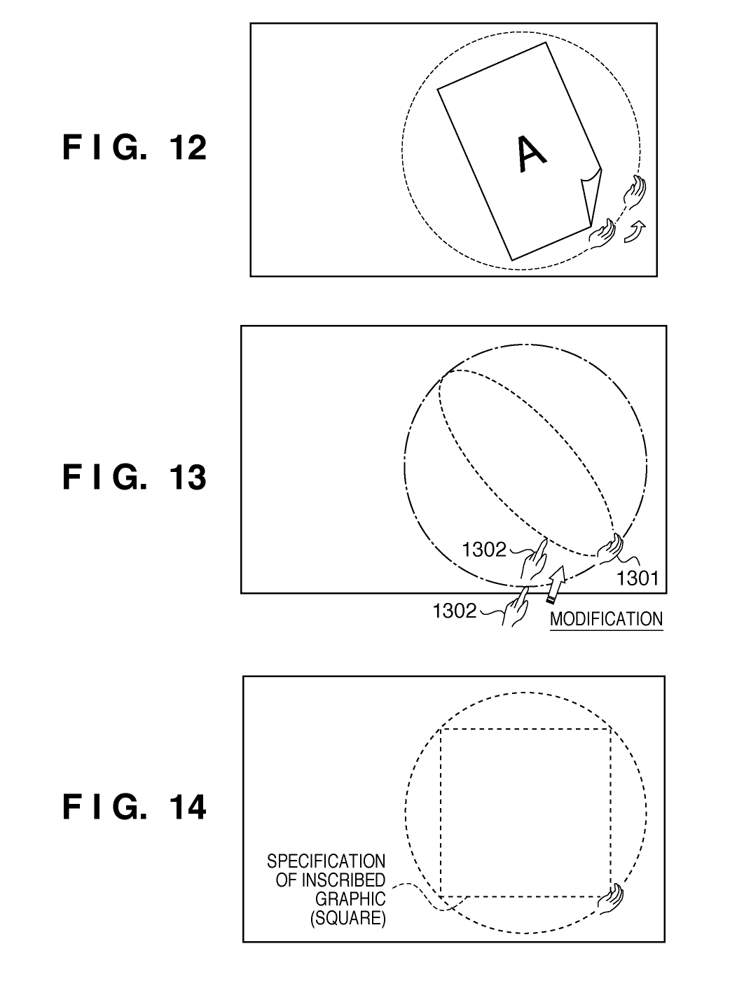

Although the methods shown in FIGS. 9A and 9B are shown for rotation of the selected range, the object may also be rotated by enabling rotation manipulation as shown in FIG. 12. This process may be done upon detection of the movement of the side of a hand beside the outer circumference of the selected range, as shown in FIG. 12.

Although a case that manipulates an object is described above, there may be one or a plurality of objects inside the selected range 1101. If there is a plurality of objects in the selected range 1101, they may be collectively moved, magnified or reduced. As for determining whether or not the object is included in the selected range 1101, it may be determined by a determination such as determining whether or not a certain proportion or more of the displayed object is included in the selected range. For example, if 70% or more of an area of the displayed object is included in the selected range 1101, it is assumed that the object is inside the selected range. Moreover, in a case in which there are a lot of objects, or in a case in which there is an object close to a determination condition for determining whether or not it is within a selected range, it is difficult to determine which object is selected. For this reason, the object determined as being inside the selected range may be displayed to be emphasized so as to show that it is being selected. As for the method of displaying an object to be emphasized, there is no limitation to the above method, and any method may be used from among various methods such as adding a mark, frame, or coloring.

In accordance with the second embodiment, the display of the objects in the selected range is changed based on the change of the contacted area having a predetermined shape which was detected as being within a predetermined distance from the selected range, after the selected range is fixed by the procedure described in the first embodiment. Examples of changing the display of an object include magnification, reduction, translation, and rotation. Therefore, by changing the condition of a curve of the side of a hand while making contacting between the side of a hand and the multi-touch panel, the user can perform manipulation of the object, and more intuitive manipulation can be achieved.

Although magnification and reduction of the selected range is performed by bending and stretching the hand in the aforementioned first embodiment, there are cases in which the user unintentionally bends and stretches the hand upon translation and rotation of the selected range. It is preferable to avoid the selected range repeatedly becoming large and small during translation or rotation, in consideration of the objective of fixing the selected range. Therefore, an arrangement in which manipulations are not accepted during the translation and rotation, and the magnification and reduction are locked is possible. Similarly, an arrangement such that a slight translation or rotation is ignored during the magnification and reduction manipulation is possible. Accordingly, the operability of the manipulation is improved by inhibiting a change in the size of the selected range while the selected range is being moved.

In the above second embodiment, placing and fixing the selected range circle, and translation, rotation, magnification, and reduction of the selected range circle are described. Upon these manipulations, an arrangement in which manipulation to modify the selected range circle is accepted is possible. For example, the selected range may be specified with one hand 1301, while the selected range circle may be modified with the other hand 1302, as shown in FIG. 13. FIG. 13 shows an example of modification of the selected range from a circle to an ellipse. As described above, when the selected range placing unit 205 detects an input of a contact that is not included in the contacted area where the selected range is determined within a predetermined distance from the placed selected range, the shape of the contacted area is changed based on the position of said contact.

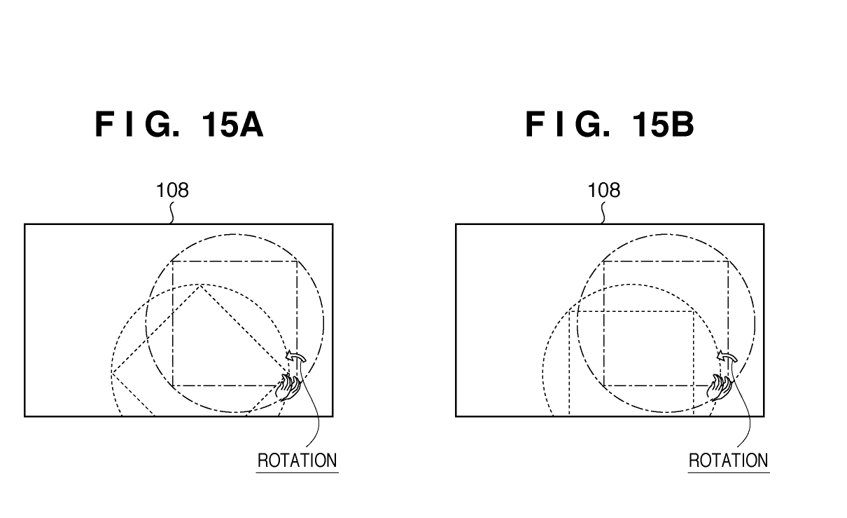

Methods for placing the selected range circle have already been described in the description of the aforementioned first embodiment, but needless to say, by setting the initial shape to another graphic that is inscribed within the selected range circle, for example, a selected range other than the circle may be handled as shown in FIG. 14 (FIG. 14 exemplifies a square). Moreover, in movement of the inscribed graphic in response to rotation of the selected range circle as shown in FIGS. 9A and 9B, the inscribed graphic also rotates along with the rotation of the selected range circle (FIGS. 15A and 15B). This manipulation is advantageous in that the object for selection can be effectively placed within the range by intentionally performing the rotation, depending on the shape of the inscribed graphic. On the other hand, if the side of a hand is rotated unintentionally, during the movement of the selected range including mainly the translations, and the magnification and reduction, etc., there are cases in which it is preferable to avoid tilting of the selected range that occurs at every rotation. In such a case, the rotation of the inscribed graphic may be locked during rotation of the selected range circle, as in FIG. 15B. It is noted that the behavior during rotation need not be one of the other of the two ways described herein. It may be automatically switched in accordance with a suitable case as described in the above, or may be switched according to input manipulations by the user.

Although methods that place the initial selected range circle from the shape of a hand have been described in the aforementioned embodiments, the present invention is not limited to these, and may be arranged to place a selected range having a shape following the shape of a hand. In other words, the shape of the selected range may be determined according to the shape of the determined contacted area. For example, an area in which the side of a hand is bent at a right angle may be made recognizable in addition to the case in which the side of a hand is bent in an arc shape, so that a selected range having a circular shape is placed if the area of the side of a hand has an arc shape, and a selected range having a rectangular shape is placed if it has the shape of a right angle.

Although the side of a hand is assumed to be an area necessary for placing an initial selected range in the above embodiments, the only requirement is that the shape for determining the selected range can be detected by the multi-touch panel, and it does not necessarily need to be a side of a hand. For example, an initial selected range may be placed by detecting, for example, fingertips aligned into an arc shape as a contact area of a predetermined shape. Furthermore, for example, as an input instruction to the multi-touch panel, the action of drawing an arc with a finger may be recognized as a gesture, and upon recognition of the gesture, the selected range may be placed according to the arc based on the area of the drawn arc. As for the change in size of the selected range and movement of the range which is fixed by drawing an arc with a finger, an arrangement described in the second embodiment may be used.

In accordance with the exemplary embodiments of the present invention described above, the user of the touch panel can easily specify a selected range including a range which the hand cannot reach.

Although embodiments of the present invention were described above in detail, the present invention may be in a form such as a system, device, process, program, or storage medium. Specifically, the present invention may be applied to a system comprised of a plurality of appliances, or to a device comprising a single appliance.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-198621, filed Jul. 31, 2008, which is hereby incorporated by reference herein in its entirety.

What is claimed is:

1. An information processing apparatus for controlling a multi-touch panel, comprising:
an acquisition unit configured to acquire a contacted area in said multi-touch panel;
a determination unit configured to determine whether or not said contacted area acquired by said acquisition unit has a predetermined shape; and
a placing unit configured to place a selected range based on a detection position in said contacted area if said determination unit determines that said contacted area has the predetermined shape.

2. The apparatus according to claim 1, wherein said acquisition unit acquires as said contacted area an area where a plurality of contacted positions that are detected at the same time by said multi-touch panel are present with a density greater than or equal to a predetermined density.

3. The apparatus according to claim 1, wherein said placing unit further comprises a unit configured to determine a size of said selected range based on a shape of said contacted area.

4. The apparatus according to claim 3, wherein
said contacted area has a curved shape, and
said placing unit uses a circle having a size determined based on said curved shape as said selected range, and places said circle having its size determined besides said curved shape.

5. The apparatus according to claim 1, further comprising a change unit configured to change a size of said selected range according to a change in a shape of the contacted area acquired by said acquisition unit.

6. The apparatus according to claim 5, wherein said change unit performs a movement of said selected range in accordance with a movement of said contacted area.

7. The apparatus according to claim 6, wherein said change unit inhibits a change of a size of said selected range during the movement of said selected range.

8. The apparatus according to claim 6, wherein said change unit inhibits a movement of said selected range during a change of a size of said selected range.

9. The apparatus according to claim 1, further comprising a fixing unit configured to fix said selected range placed by said placing unit, if said acquisition unit detected a disappearance of said contacted area.

10. The apparatus according to claim 9, further comprising a change unit, wherein after a selected range is fixed by said fixing unit, if said acquisition unit detected a contacted area having a predetermined shape within a predetermined distance from the selected range, the change unit changes a display of an object selected using said selected range based on a change of said contacted area, by performing on the object at least one of magnification, reduction, translation, or rotation.

11. The apparatus according to claim 1, further comprising a change unit configured to change, wherein if a contact that is not included in said contacted area is detected within a predetermined distance from said selected range placed by said placing unit, the change unit changes a shape of said selected range based on a position of said contact.

12. The apparatus according to claim 1, wherein a shape of said selected range is determined in accordance with a shape of said contacted area determined by said determination unit.

13. A method for controlling an information processing apparatus that controls a multi-touch panel, comprising:
acquiring a contacted area contacted in said multi-touch panel;
determining whether or not said acquired contacted area has a predetermined shape;
placing a selected range based on a detection position of said acquired contacted area if said acquired contacted area is determined to have the predetermined shape;
displaying said placed selected range in said multi-touch panel.

14. A computer readable storage medium which stores a program for executing the method for controlling an information processing apparatus according to claim 13 by a computer.
